(19) United States
(12) Patent Application Publication
(10) Pub. No.: US 2025/0355193 A1
(43) Pub. Date: Nov. 20, 2025

(54) CONNECTOR ASSEMBLY AND DROP CABLE ASSEMBLY FOR FIBER OPTIC CABLE

(71) Applicant: AFL Telecommunications LLC, Duncan, SC (US)

(72) Inventors: Jonathan Fang, Duncan, SC (US); Ted Lichoulas, Duncan, SC (US); Seiji Kato, Duncan, SC (US)

(21) Appl. No.: 18/872,312

(22) PCT Filed: Jun. 6, 2023
(86) PCT No.: PCT/US2023/024526

§ 371 Date: Dec. 6, 2024

Related U.S. Application Data
(60) Provisional application No. 63/349,316, filed on Jun. 6, 2022.

(51) Int. Cl. G02B 6/38; G02B 6/44

(52) U.S. Cl. CPC G02B 6/3869; G02B 6/3821; G02B 6/44715

(57) ABSTRACT

A fiber optic drop cable assembly and fiber optic connector assembly are provided. The connector assembly includes an inner body assembly extending along a longitudinal direction. The inner body assembly includes a second crimp body surrounding at least a portion of a first crimp body. An inner body housing surrounds at least a portion of a ferrule and a spring and is coupled to the first crimp body. The spring is positioned within the inner body housing and is positioned to exert a force to the ferrule and the first crimp body along the longitudinal direction. The inner body assembly forms a first end configured to receive a first optical fiber into the first and second crimp body. The inner body assembly forms a second end opening configured to receive a second optical fiber from the ferrule.

### CROSS-REFERENCE TO RELATED APPLICATIONS

The present application claims priority to U.S. Provisional Patent Application No. 63/349,316 filed on Jun. 6, 2022, the disclosure of which is incorporated by reference herein in its entirety.

### FIELD

The present disclosure relates generally to fiber optic communications networks, and more particularly to fiber optic connectors and drop cable assemblies for use in fiber optic communications networks.

### BACKGROUND

Optical fiber is increasingly being used for a variety of applications, including broadband applications such as voice, video and data transmissions. As a result of this increasing demand, fiber optic networks typically include a large number of mid-span access locations at which one or more optical fibers are branched from a distribution cable. These mid-span access locations provide a branch point from the distribution cable and may lead to an end user, commonly referred to as a subscriber. Fiber optic networks which provide such access are commonly referred to as FTTX “fiber to the X” networks, with X indicating a delivery point such as a home (i.e., FTTH).

Drop cables are utilized to connect the end user to the distribution cable and thus the fiber optic network. For example, multi-port optical connection terminals have been developed for interconnecting drop cables with a fiber optic distribution cable at a predetermined branch point in a fiber optic network between a mid-span access location on the distribution cable and a delivery point such as a subscriber premises. Utilizing such terminals, drop cables extending from a delivery point may be physically connected to the communications network at the branch point provided by such terminals as opposed to at the actual mid-span access location provided on the distribution cable. Alternatively, however, drop cables may connect to the distribution cable at the mid-span access location.

Multi-port optical connection terminals, from which single-fiber drop cables extend to a subscriber, are required to meet standards for outside plant (OSP) environmental conditions while also facilitating network extension to the subscriber. Generally, larger connection terminals require larger and more complex structures for mounting, or may require greater volumes or spaces at a utility pole, underground volume, or other appropriate structure. Such spaces may be rented, and accordingly, rent costs may vary directly based on size and complexity of the connection terminal.

Accordingly, improved drop cable assemblies and connection assemblies for fiber optic communications networks would be advantageous. In particular, improved fiber optic drop cable assemblies and fiber optic connector assemblies for fiber to the X at a telecommunications network would be desirable.

### BRIEF DESCRIPTION

Aspects and advantages of the cable support devices and assemblies in accordance with the present disclosure will be set forth in part in the following description, or may be obvious from the description, or may be learned through practice of the technology.

An aspect of the present disclosure is directed to a fiber optic connector assembly. The fiber optic connector assembly defines a first end and a second end each separated along a longitudinal direction corresponding to a longitudinal extension of a cable. The fiber optic connector assembly includes an inner body assembly extending along the longitudinal direction. The inner body assembly includes an inner body housing, a ferrule, a spring, a first crimp body, and a second crimp body. The second crimp body surrounds at least a portion of the first crimp body proximate to the first end. The inner body housing surrounds at least a portion of the ferrule and the spring. The inner body housing is coupled proximate to the second end at the first crimp body. The spring is positioned within the inner body housing. The spring extends along the longitudinal direction. The spring is positioned along the longitudinal direction between at least a portion of the ferrule and the first crimp body. The spring is positioned to exert a force to the ferrule and the first crimp body along the longitudinal direction. The ferrule extends along the longitudinal direction within at least a portion of the inner body housing and the first crimp body. The inner body assembly forms a first end opening configured to receive a first optical fiber from the first end into the first crimp body and the second crimp body. The inner body assembly forms a second end opening configured to receive a second optical fiber from the second end at the ferrule.

Another aspect of the present disclosure is directed to a fiber optic drop cable assembly. The fiber optic drop cable assembly defines a first end and a second end each separated along a longitudinal direction. The fiber optic drop cable assembly includes a transition apparatus configured to receive a connectorized multi-fiber input cable and output one or more first output cables, a fiber optic connector assembly, a first connector body, a second connector body, and a second output cable extending from the second connector body. The fiber optic connector assembly includes an inner body assembly extending along the longitudinal direction. The inner body assembly includes an inner body housing, a ferrule, a spring, a first crimp body, and a second crimp body. The first connector body is coupled to the second crimp body and surrounds at least a portion of the first crimp body. Each first output cable is configured to be received at each respective fiber optic connector assembly at the first connector body. The second connector body is coupled to the inner body housing. The second connector body is releasably attached to the first connector body. The first connector body and the second connector body together surrounding the fiber optic connector assembly.

These and other features, aspects and advantages of the present cable support devices and assemblies will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION

A full and enabling disclosure of the present cable support devices and assemblies, including the best mode of making and using the present systems and methods, directed to one of ordinary skill in the art, is set forth in the specification, which makes reference to the appended figures, in which:

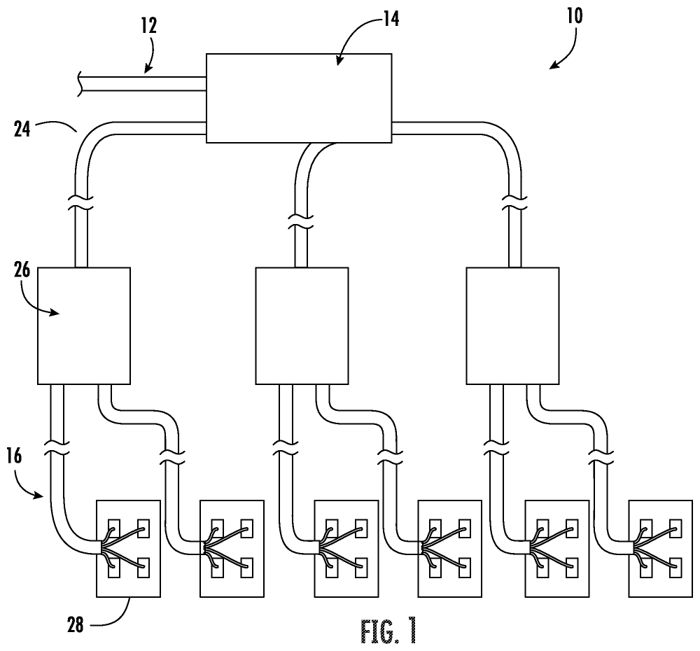

FIG. 1 is a schematic illustration of a fiber optic communications network;

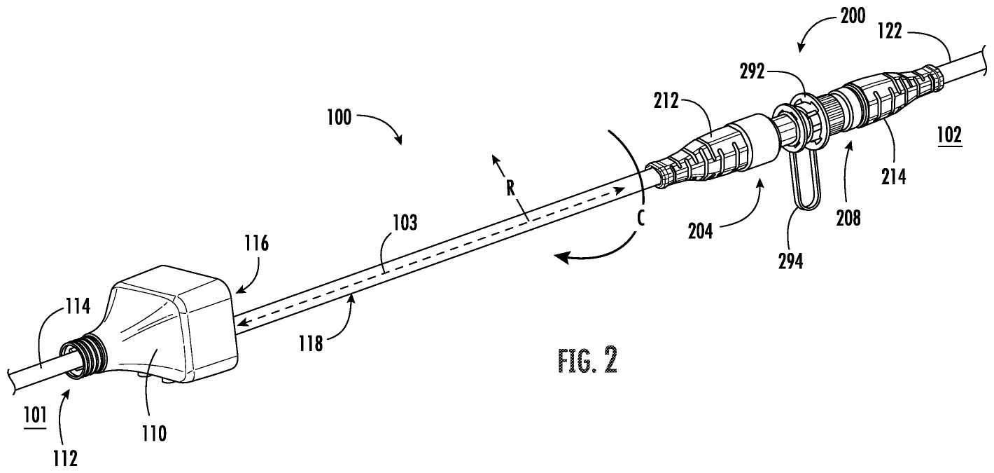

FIG. 2 is a perspective illustration of a fiber optic drop cable assembly in accordance with embodiments of the present disclosure;

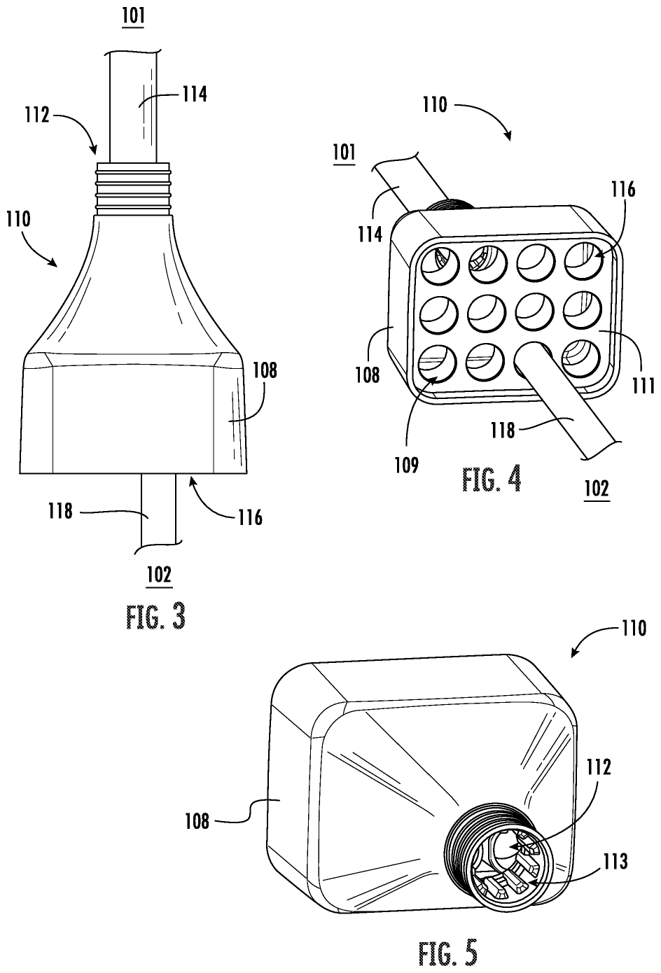

FIG. 3 is a top-down view of a transition apparatus of the fiber optic drop cable assembly in accordance with embodiments of the present disclosure;

FIG. 4 is a perspective view of the transition apparatus of the fiber optic drop cable assembly in accordance with embodiments of the present disclosure;

FIG. 5 is a perspective view of the transition apparatus of the fiber optic drop cable assembly in accordance with embodiments of the present disclosure;

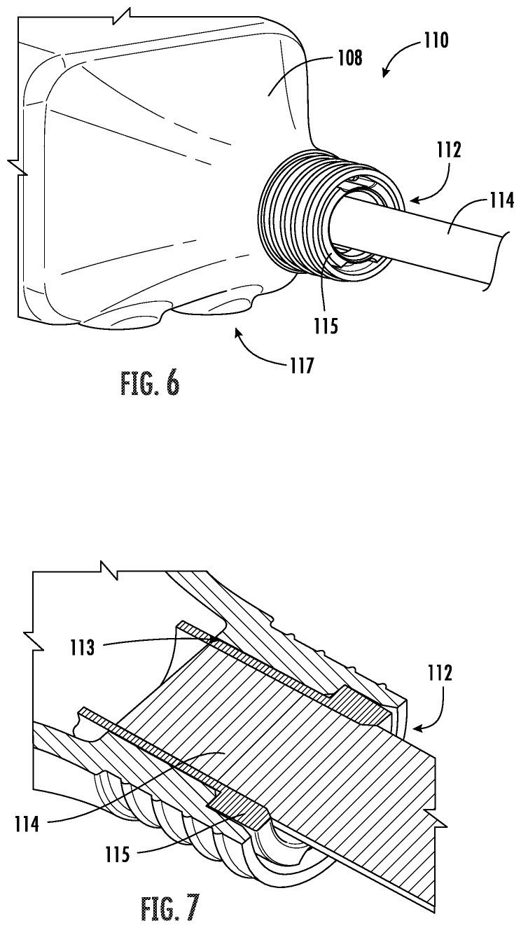

FIG. 6 is a perspective view of the transition apparatus of the fiber optic drop cable assembly in accordance with embodiments of the present disclosure;

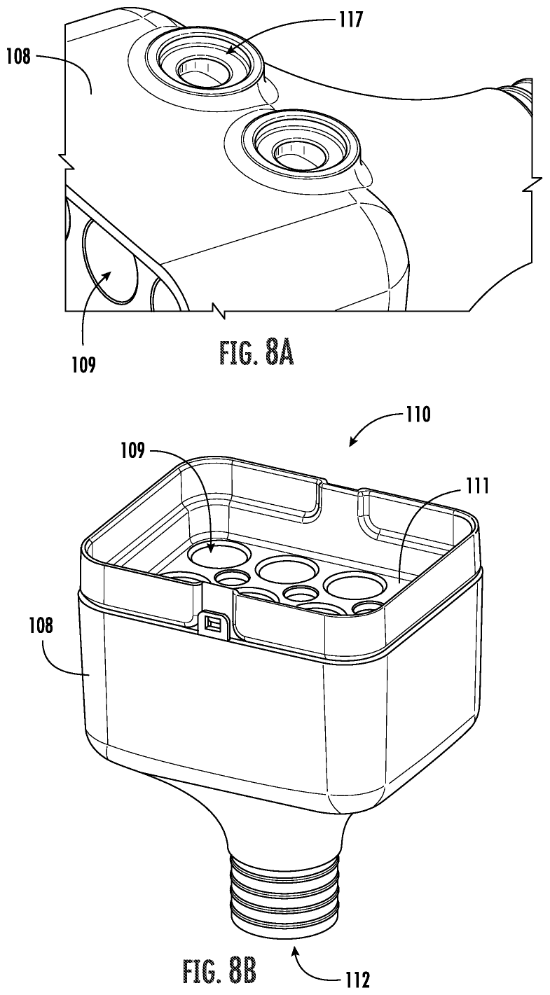

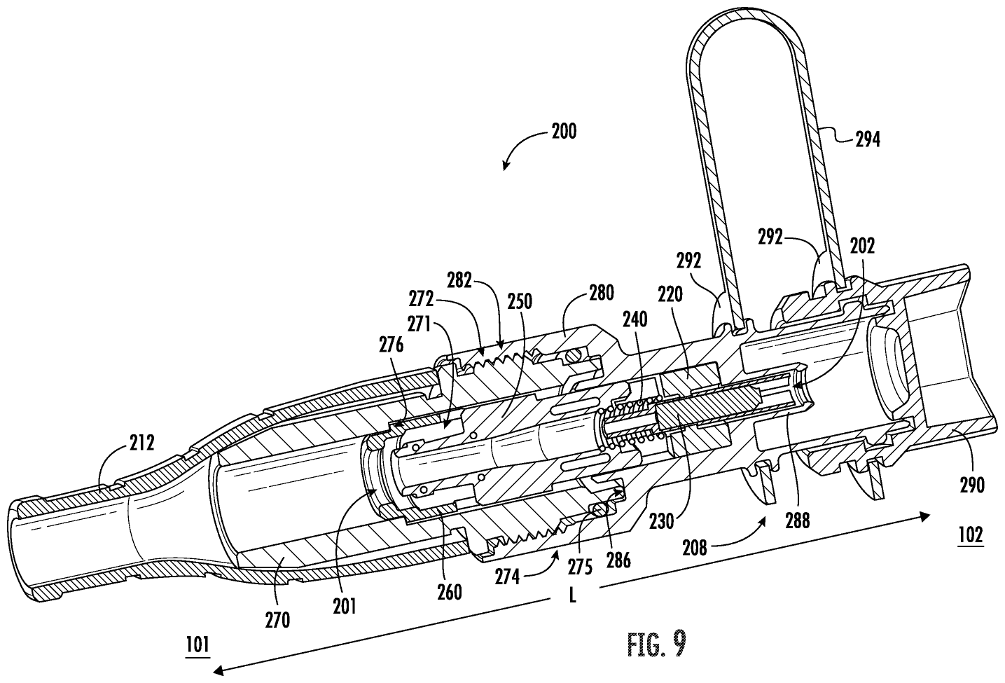

FIG. 7 is a cutaway perspective view of a portion of the transition apparatus of the fiber optic drop cable assembly in accordance with embodiments of the present disclosure;

FIG. 8A is a perspective view of a portion of the transition apparatus of the fiber optic drop cable assembly in accordance with embodiments of the present disclosure;

FIG. 8B is a perspective view of a portion of the transition apparatus of the fiber optic drop cable assembly in accordance with embodiments of the present disclosure;

FIG. 9 is a cutaway perspective view of a fiber optic connector assembly in accordance with embodiments of the present disclosure;

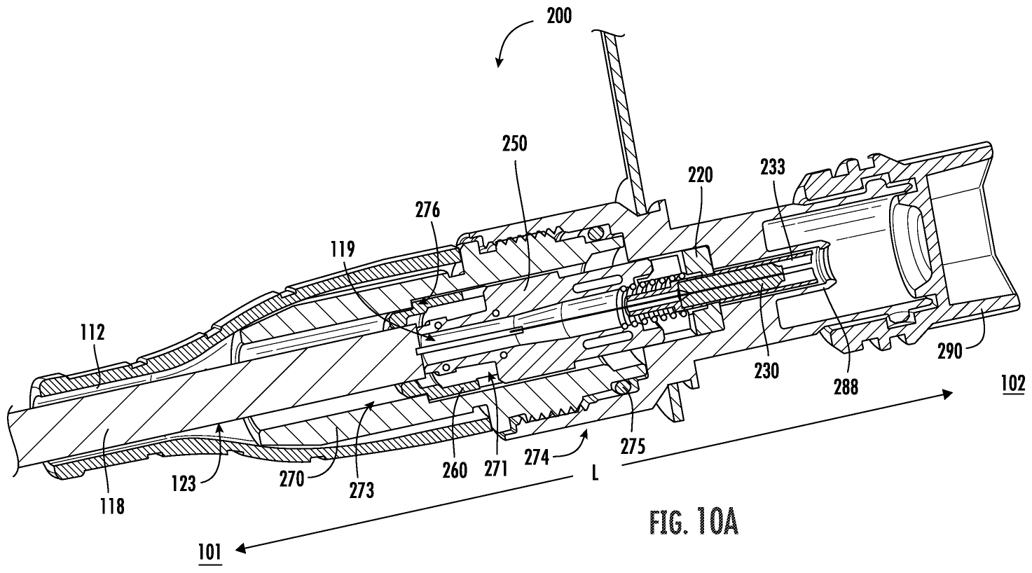

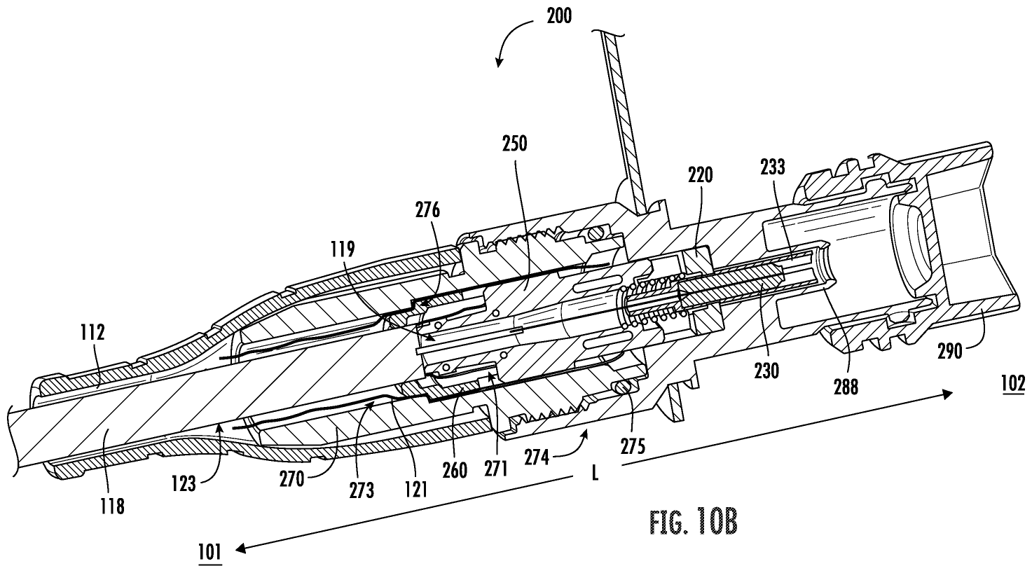

FIG. 10A is a cutaway perspective view of a fiber optic connector assembly in accordance with embodiments of the present disclosure;

FIG. 10B is a cutaway perspective view of a fiber optic connector assembly in accordance with embodiments of the present disclosure;

FIG. 11 is a perspective view of a fiber optic connector assembly in accordance with embodiments of the present disclosure;

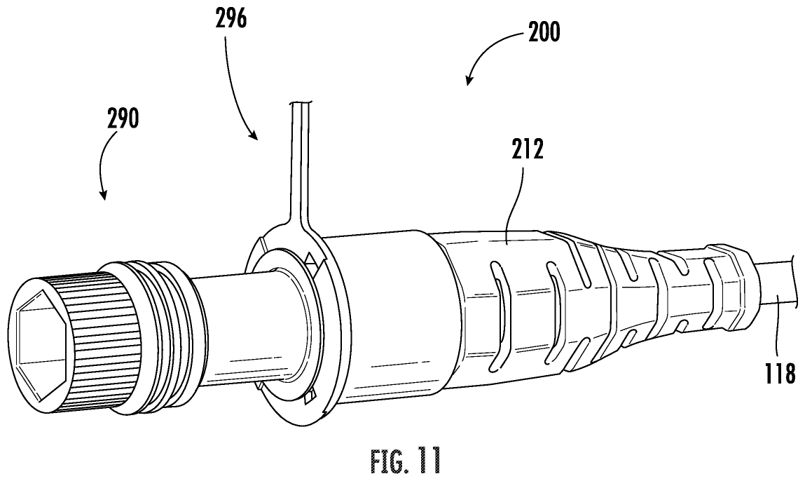

FIG. 12 is a perspective view of an inner body assembly of the fiber optic connector assembly in accordance with embodiments of the present disclosure;

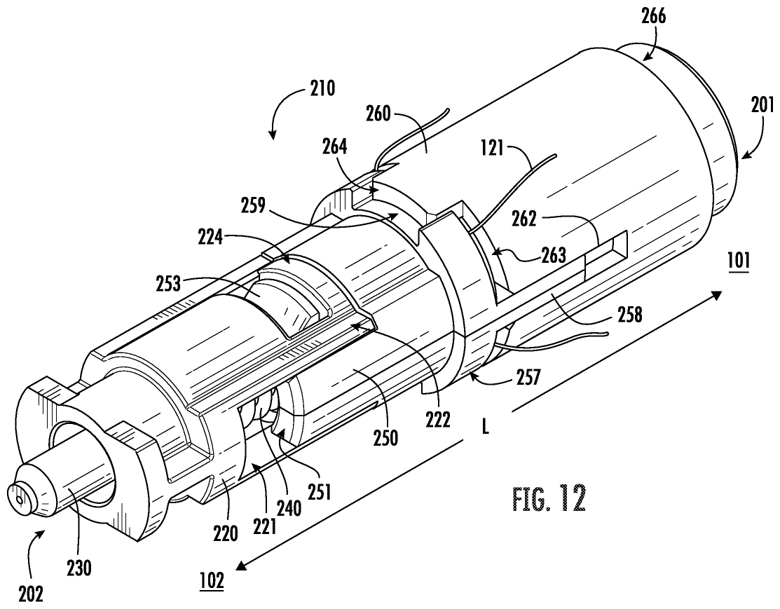

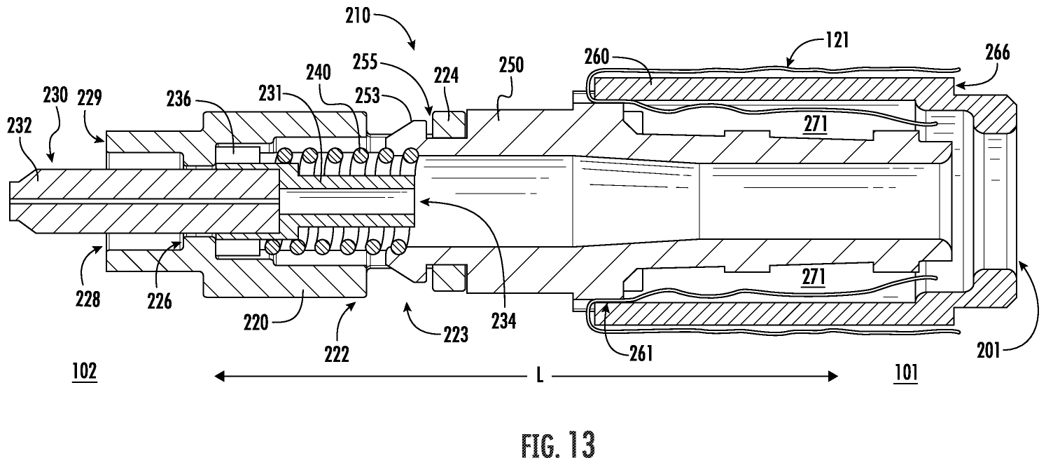

FIG. 13 is a cutaway side view of the inner body assembly of the fiber optic connector assembly in accordance with embodiments of the present disclosure;

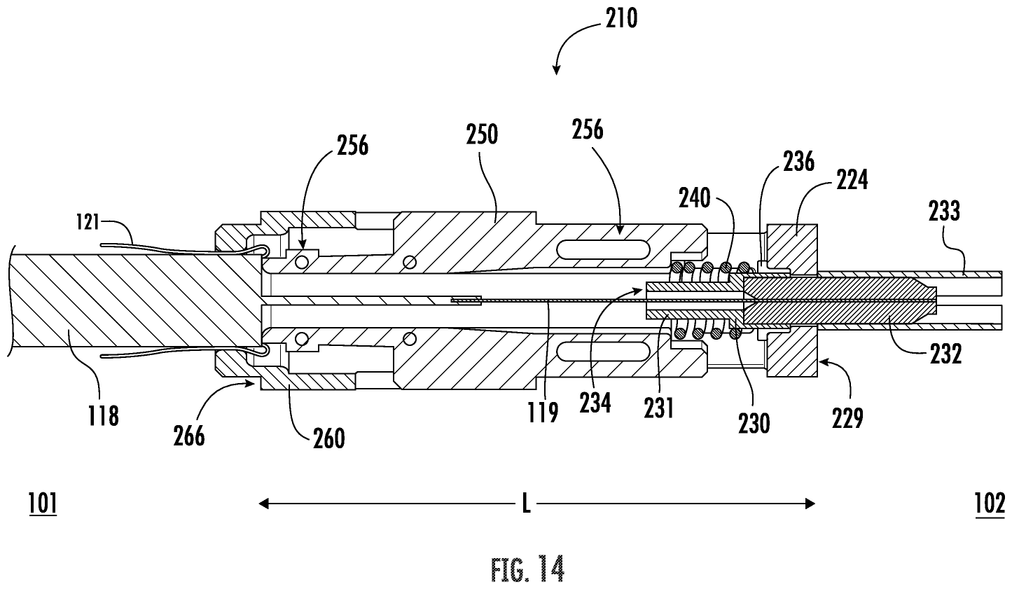

FIG. 14 is a cutaway side view of the inner body assembly of the fiber optic connector assembly in accordance with embodiments of the present disclosure;

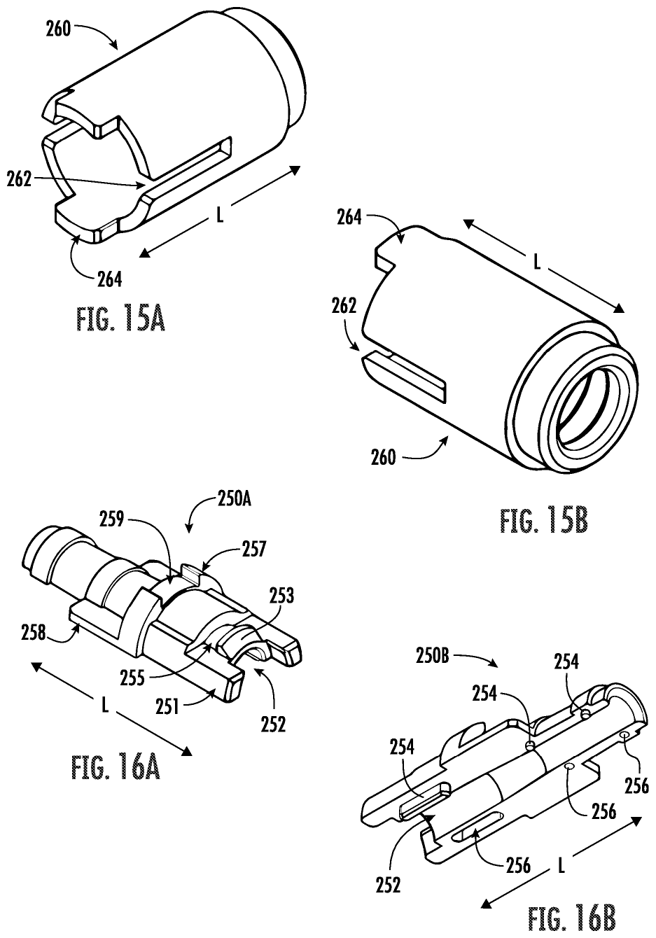

FIG. 15A is a perspective view of a second crimp body of the inner body assembly in accordance with embodiments of the present disclosure;

FIG. 15B is a perspective view of the second crimp body of the inner body assembly in accordance with embodiments of the present disclosure;

FIG. 16A is a perspective view of a first crimp body of the inner body assembly in accordance with embodiments of the present disclosure;

FIG. 16B is a perspective view of the first crimp body of the inner body assembly in accordance with embodiments of the present disclosure;

FIG. 17A is a perspective view of an inner body housing of the inner body assembly in accordance with embodiments of the present disclosure;

FIG. 17B is a perspective view of the inner body housing of the inner body assembly in accordance with embodiments of the present disclosure;

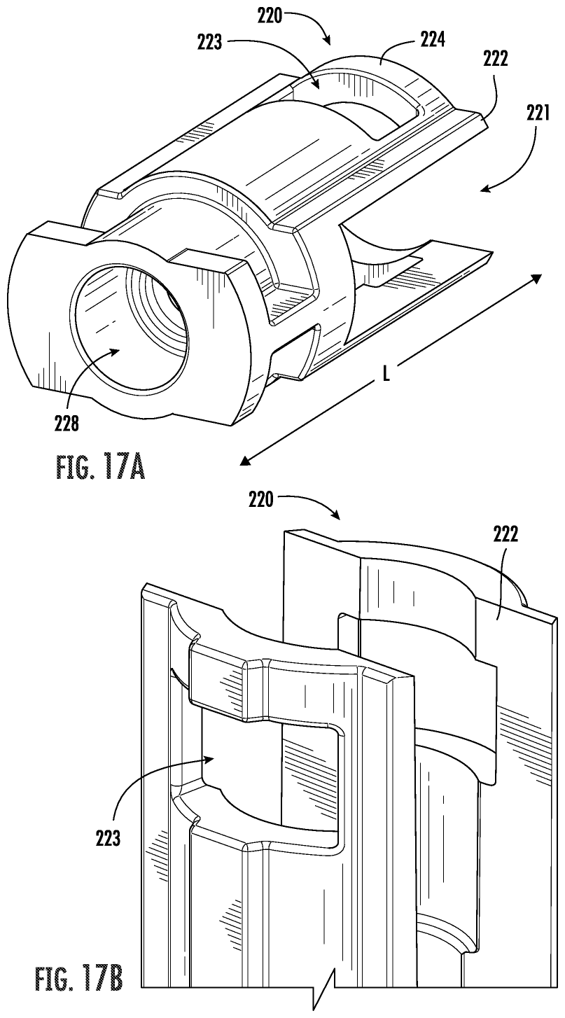

FIG. 18 is a perspective view of a ferrule of the inner body assembly in accordance with embodiments of the present disclosure;

FIG. 19 is a perspective view of a first connector body of the fiber optic connector assembly in accordance with embodiments of the present disclosure;

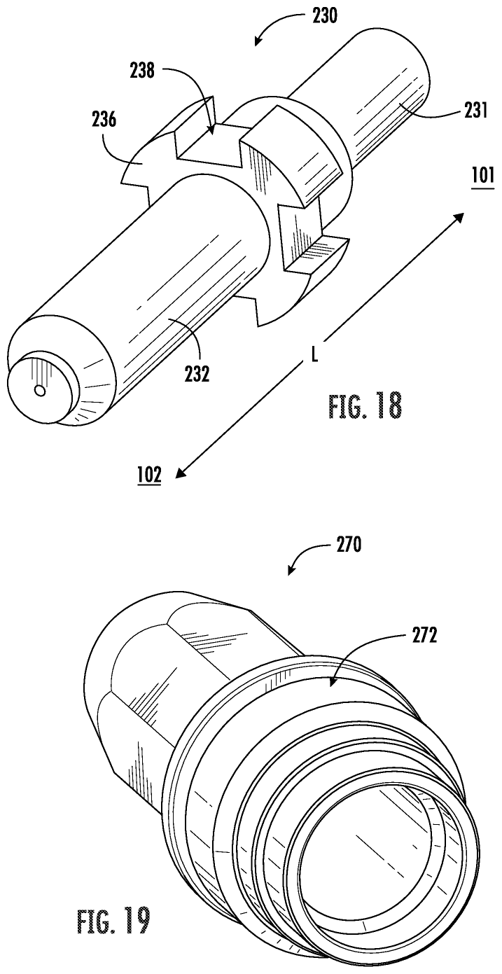

FIG. 20 is a perspective view of a second connector body of the fiber optic connector assembly in accordance with embodiments of the present disclosure;

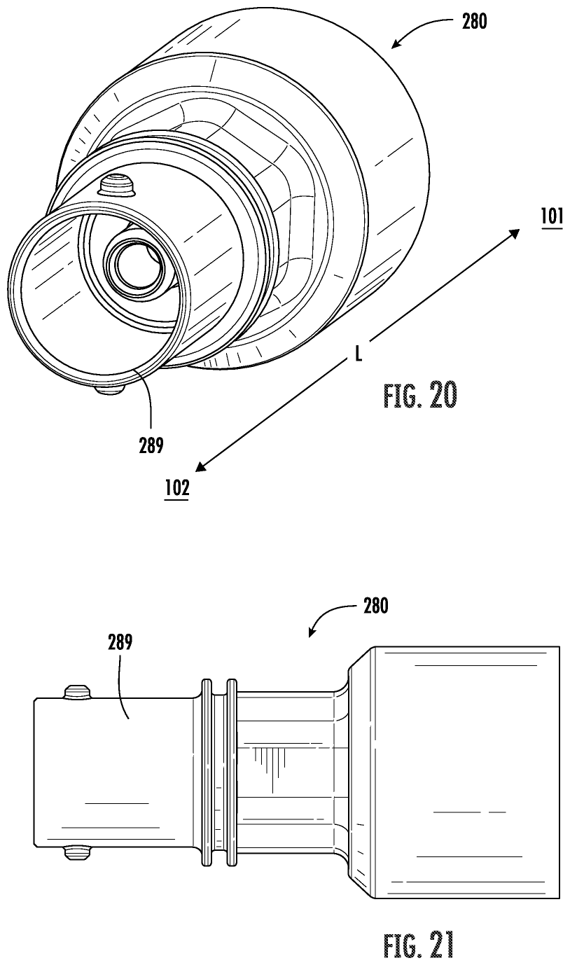

FIG. 21 is a side view of the second connector body of the fiber optic connector assembly in accordance with embodiments of the present disclosure;

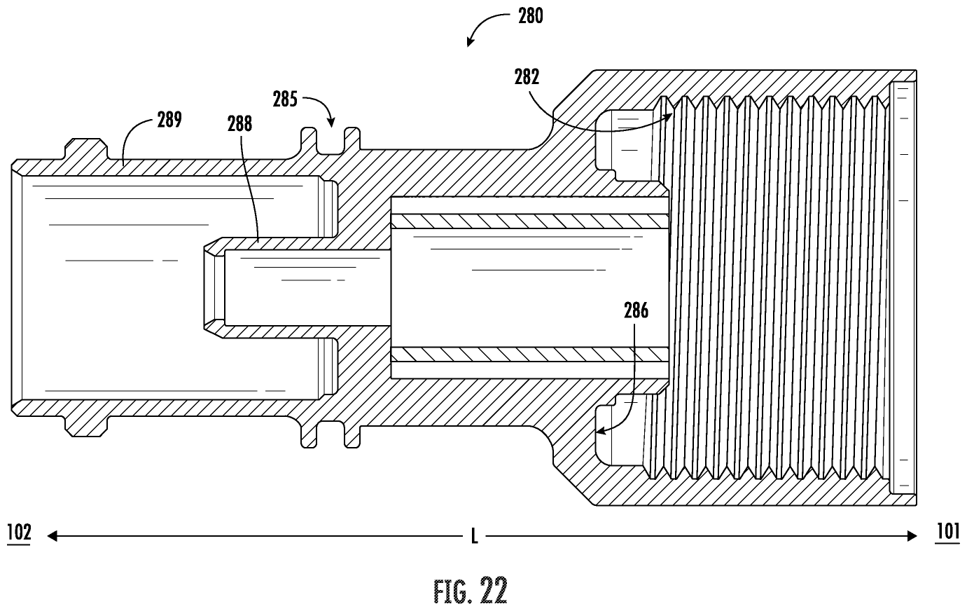

FIG. 22 is a cutaway side view of the second connector body of the fiber optic connector assembly in accordance with embodiments of the present disclosure;

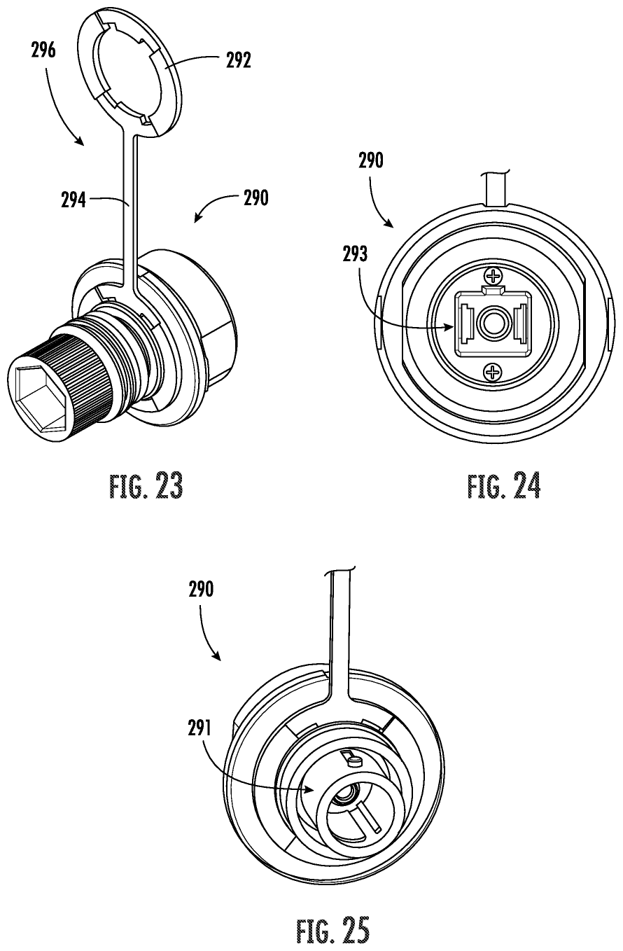

FIG. 23 is a perspective view of a connector adapter of the fiber optic connector assembly in accordance with embodiments of the present disclosure;

FIG. 24 is a cable axis view of the connector adapter of the fiber optic connector assembly in accordance with embodiments of the present disclosure;

FIG. 25 is a perspective view of the connector adapter of the fiber optic connector assembly in accordance with embodiments of the present disclosure;

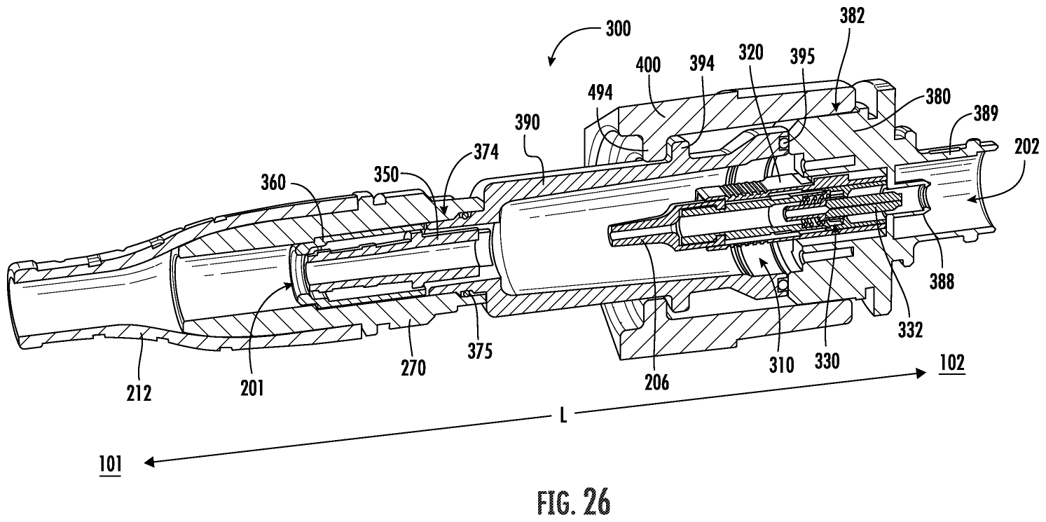

FIG. 26 is a cutaway perspective view of a fiber optic connector assembly in accordance with embodiments of the present disclosure;

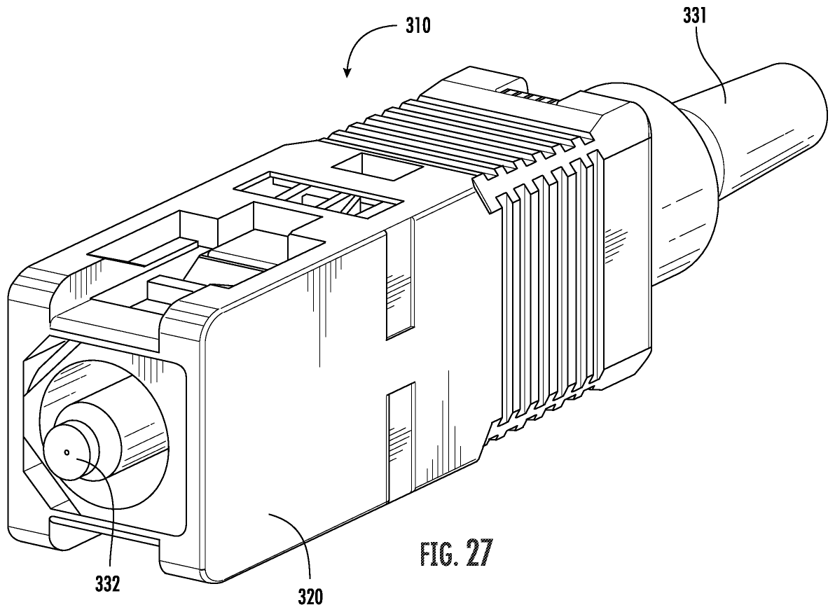

FIG. 27 is a perspective view of a fiber optic connector of the fiber optic connector assembly in accordance with embodiments of the present disclosure;

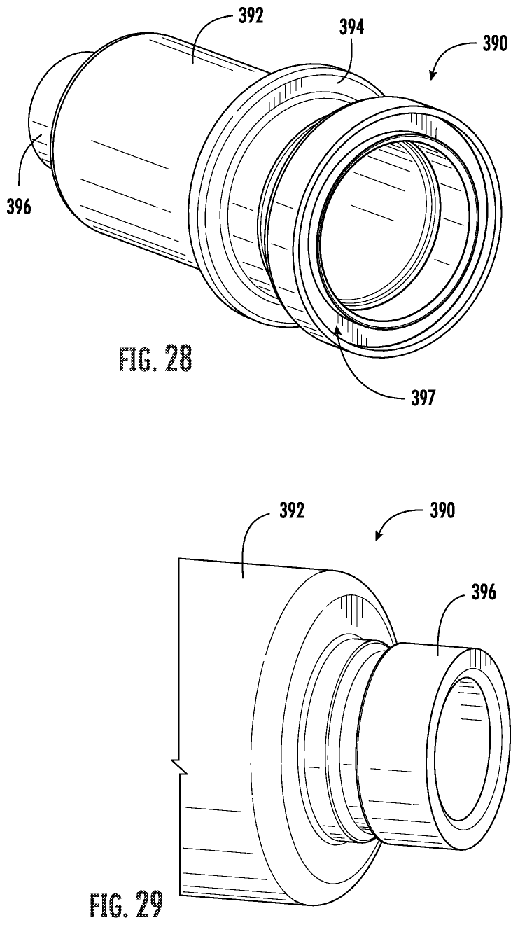

FIG. 28 is a perspective view of a middle body of the fiber optic connector assembly in accordance with embodiments of the present disclosure;

FIG. 29 is a perspective view of a portion of the middle body of the fiber optic connector assembly in accordance with embodiments of the present disclosure;

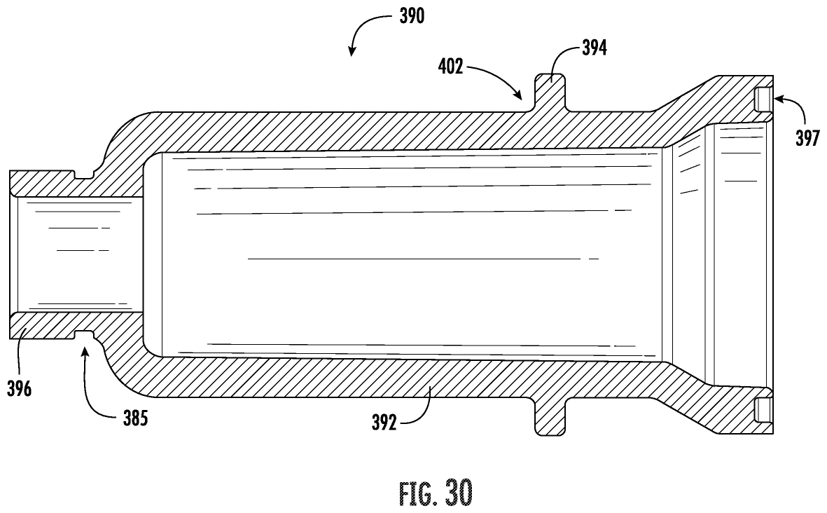

FIG. 30 is a cutaway side view of the middle body of the fiber optic connector assembly in accordance with embodiments of the present disclosure;

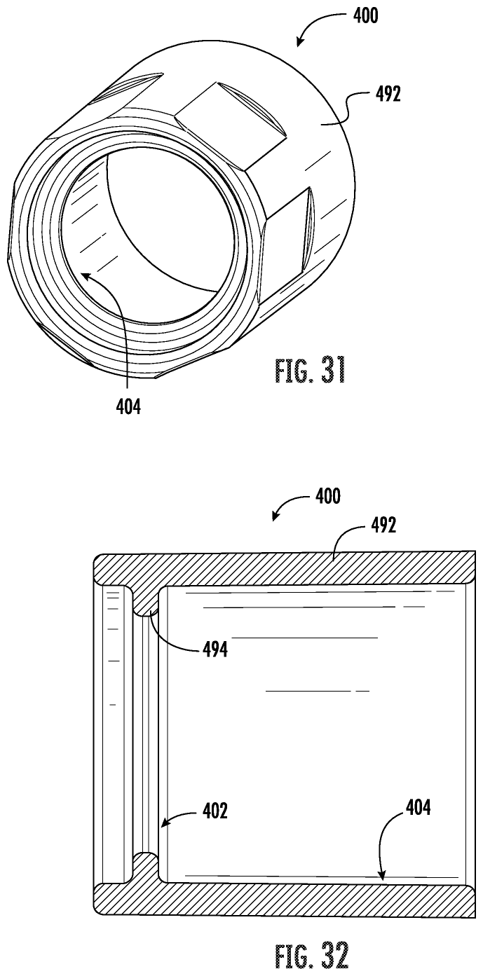

FIG. 31 is a perspective view of an outer body of the fiber optic connector assembly in accordance with embodiments of the present disclosure;

FIG. 32 is a cutaway side view of the outer body of the fiber optic connector assembly in accordance with embodiments of the present disclosure; and

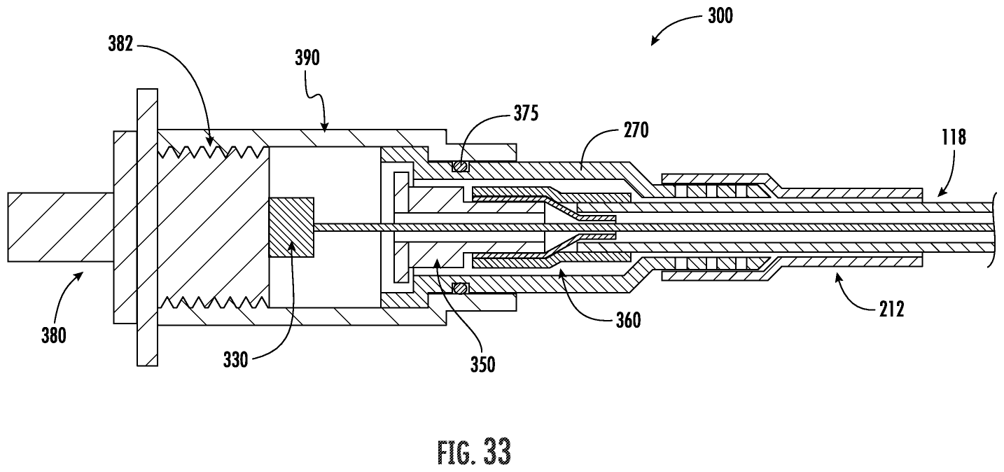

FIG. 33 is a cutaway perspective view of a fiber optic connector assembly in accordance with embodiments of the present disclosure.

### DETAILED DESCRIPTION

Reference now will be made in detail to embodiments of the present cable support devices and assemblies, one or more examples of which are illustrated in the drawings. Each example is provided by way of explanation, rather than limitation of, the technology. In fact, it will be apparent to those skilled in the art that various modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

As used herein, the terms “upstream” (or “forward”) and “downstream” (or “aft”) refer to the relative direction with respect to fluid flow in a fluid pathway. For example, “upstream” refers to the direction from which the fluid flows, and “downstream” refers to the direction to which the fluid flows. The term “radially” refers to the relative direction that is substantially perpendicular to an axial centerline of a particular component, the term “axially” or “longitudinally” refers to the relative direction that is substantially parallel and/or coaxially aligned to an axial centerline of a particular component and the term “circumferentially” refers to the relative direction that extends around the axial centerline of a particular component. Terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

As described further herein, embodiments of a fiber optic drop cable assembly and fiber optic connector assembly are provided. Embodiments of the drop cable assembly and connector assembly allow for a multi-fiber entry point to be divided and separated by a fan-out cable into a plurality of single-fiber output cables. Each single-fiber output cable is assembled to a hardened connector appropriate for outside plant (OSP) conditions, such as between a closure and a connection terminal at a delivery point (e.g., a subscriber). Embodiments of the drop cable assembly and connector assembly provided herein may be utilized in place of conventional drop terminal closures, such as may mount from a utility pole or other structure, to facilitate subscriber field connection. Furthermore, embodiments of the drop cable assembly and connector assembly provided herein allow for durability, reliability, and functionality required for OSP terminals, closures, underground volumes, pedestals, poles, aerial strands, or ADSS cables, while furthermore reducing size, weight, complexity, and spatial rigidness associated with structures for fiber to the X, or fiber in the loop, used in network architecture for a final distance (e.g., within approximately one mile) of a telecommunications network to the subscriber or connection terminal.

Referring now to FIG. 1, a portion of a fiber optic communications network 10 including a fiber optic distribution cable 12 is shown. One or more mid-span access locations are provided along the length of the distribution cable 12. The mid-span access location may be enclosed and protected from exposure to the environment by a conventional closure 14. The fiber optic communications network 10 may include a fiber optic distribution cable 12 having a plurality of mid-span access locations at branch points spaced along the length of the distribution cable, each providing access to at least one, and preferably, a plurality of optical fibers of the fiber optic network. Thus, in the embodiments shown, the distribution cable 12 may provide multiple locations for joining stub cables 24 of multi-port optical connection terminals 26 to the distribution cable 12 at each mid-span access location.

In the fiber optic network 10 as illustrated, pre-terminated optical fibers of the distribution cable 12 provided at the mid-span access location are routed out of the distribution cable and spliced to respective optical fibers of a stub cable 24 extending from a multi-port optical connection terminal 26. The optical fibers of the stub cable 24 may enter the closure 14 through a suitable cable port provided through an exterior wall, for example an end wall, of the closure 14. The stub cable 24 includes at least one, and preferably a plurality of optical fibers disposed within a protective cable sheath. The stub cable 24 may, for example, be any known fiber optic cable which includes at least one optical fiber and having a fiber count equal to or greater than that of a drop cable 16 to be connected to the multi-port optical connection terminal 26 and equal to or less than that of the distribution cable 12.

The stub cable 24 may extend from the closure 14 into a multi-fiber to single-fiber transition apparatus or terminal 26. The optical fibers of the stub cable 24 within the terminal 26 may be connectorized. One or more connectorized drop cables 16 may be interconnected with the connectorized optical fibers of the stub cable 24, i.e., in terminal 26. The drop cables 16 may include at least one single mode or multimode optical fiber of any type optically connected to a single fiber or multi-fiber optical connector in a conventional manner. The other ends of the drop cables 16 are optically connected to respective optical fibers of the communications network within an outside plant connection terminal 28 at a delivery point, such as an outside plant network access point (NAP) closure, local convergence cabinet (LCC), terminal, pedestal or network interface device (NID). As shown, one or more stub cables 24 extends from the closure 14 to a terminal 26 positioned at a distance from the mid-span access location, such as a telephone pole, hand-hole, vault or pedestal (not shown) in the fiber optic network 10. Each drop cable 16 extends from a terminal 26 to an outside plant connection terminal 28 located at a delivery point such as a subscriber home.

It should be understood that the present disclosure is not limited to the above-described embodiment of a fiber optic network 10, and rather that any suitable fiber optic network 10 is within the scope and spirit of the present disclosure.

Referring now to FIG. 2, an embodiment of a fiber optic drop cable assembly 100 (hereinafter, “cable assembly 100”) including a fiber optic connector assembly 200 (hereinafter, “connector assembly 200”) is provided. A reference cable axis 103 is provided extending between a first end 101 and a second end 102. The cable axis 103 corresponds to a longitudinal extension of an output cable 118, such as further described herein. In particular, the reference first end 101 corresponds to an end of the output cable 118 proximate to an input cable 114, such as further described herein. The reference second end 102 corresponds to an end of the output cable 118 distal to the input cable 114. A reference radial direction R extends from cable axis 103. A reference circumferential direction C extends around cable axis 103.

In further figures provided herein, a reference longitudinal direction L is provided corresponding substantially to a direction of extension of cable axis 103 from the first end 101 to the second end 102.

It should be appreciated that references herein to the first end 101 and the second end 102 at other components of the cable assembly 100 and the connector assembly 200 described herein provide relative positions, orientations, coordinates, or other spatial relationships at a first component, or at a first component relative to a second component. Accordingly, references to the first end 101 and the second end 102 at various components described herein do not necessarily require the input cable 114, the output cable 118, or other components of the cable assembly 100 for one skilled in the art to understand spatial relationships of other components described herein. Stated differently, references to the first end 101 and the second end 102 in regard to other components described herein are not intended to require the presence or inclusion of the input cable 114, the output cable 118, or other components of the cable assembly 100 for one skilled in the art to understand spatial relationships of other components described herein.

Embodiments of the cable assembly 100 may be included at embodiments of a fiber optic network, such as the fiber optic network 10 described in regard to FIG. 1. However, it should be understood that embodiments of the cable assembly 100 are not limited to the fiber optic network 10 described in regard to FIG. 1. Accordingly, the cable assembly 100 may be suitable for other configurations of fiber optic network within the scope and spirit of the present disclosure.

As further depicted in FIGS. 3-8, embodiments of the cable assembly 100 include a multi-fiber to single fiber transition apparatus 110 configured to receive input cable 114 and output cable 118. First output cable 118 extends from transition apparatus 110 to the connector assembly 200, such as further described herein. Second output cable 122 extends from the connector assembly 200. As described further herein, embodiments of connector assembly 200 may be configured as a single unit jack or female connector with plug or male connector. In particular embodiments, the connector assembly 200 is configured to receive a first plug or male connector 204 from the first output cable 118 and provide an opening to operably couple a second plug or male connector 208 from the second output cable 122 through a jack or female connector at the connector assembly 200.

Embodiments of transition apparatus 110 may correspond, in location and function, to terminal 26 such as described in regard to FIG. 1. Embodiments of input cable 114 may correspond, in location and function, to stub cable 24 such as described in regard to FIG. 1. Referring to FIGS. 3-8, in particular embodiments, input cable 114 is a connectorized multi-fiber cable. Transition apparatus 100 includes a body 108 forming input end opening 112 configured to receive multi-fiber inputs from input cable 114. Transition apparatus 100 includes a wall 111 forming an output end 116 forming one or more openings 109 from which respective one or more output cables 118 extend.

In certain embodiments, body 108 is a unitary component. In still certain embodiments, wall 111 is a separable structure from body 108. Each output cable 118 is extendable through wall 111 into body 108, such as to allow for operable connections between the input cable 114 and the output cable 118.

In various embodiments, input end opening 112 includes a raised spline forming a groove 113. An insert 115 is configured to engage at groove 113 at the input end opening 112. As depicted particularly in FIGS. 6-7, insert 115 may adhere or compress around input cable 114 and snap into groove 113 at the input end opening 112. Insert 115 may include any appropriate structure for flexible compression, snap, or adhesion to the input cable 114 and into groove 113.

Referring now to FIG. 8A, in certain embodiments, an access opening 117 is formed through body 108. Access opening 117 may form a hole or orifice allowing a potting material to be placed at or into body 108.

Referring now to FIG. 8B, in certain embodiments, the transition apparatus 110 includes a fastener or clip 107 configured to retain the wall 111. In particular embodiments, clip 107 mitigates movement of the wall 111 when potting material is placed at or into body 108.

In particular embodiments transition apparatus 110 forms a compact, hardened unit configured to receive a multi-fiber input cable 114, such as from a conventional closure 14 such as described in regard to stub cable 24 at FIG. 1. Transition apparatus 110 may form a compact unit that may extend from a utility pole or other structure, such as may correspond to multi-port optical connection terminal 26 (FIG. 1). Output cable 118 may be configured as a hardened single fiber drop cable. It should be appreciated that “hardened” may generally refer to structures configured for outside plant (OSP) environmental conditions such as fluid exposure, temperature exposure, wear and tear, handling, etc., such as may correspond to utility cables, closures, terminals, units, or other devices in direct exposure or contact with one or more such environmental conditions. In various embodiments, output cable 118 includes an outer jacket forming an outermost exterior surface of the output cable 118. The outer jacket may be formed from a suitable polymer, such as, but not limited to, polyethylene. The outer jacket may surround one or more buffer tubes. The buffer tube may be formed from one or more suitable polymer. The buffer tube may generally surround a central strength member. Strength fibers may surround the buffer tube within the outer jacket. Strength fibers may be formed from an aramid or other suitable material. In an embodiment, such as depicted in FIG. 10B, one or more optical fibers 119 extends within outer jacket 123. Strength fibers 121 may extend from the outer jacket 123, such as further described below. Accordingly, such structures for fiber optic cable are generally understood in the art and may furthermore be understood to be substantively and functionally different from structures not intended for OSP conditions.

Referring now to FIG. 9 and FIGS. 10A-10B, cutaway perspective views of embodiments of the fiber optic connector assembly 200 (hereinafter, “connector assembly 200”) are provided. The connector assembly 200 includes an inner body assembly 210 extending along longitudinal direction L, such as depicted in further detail in the perspective view in FIG. 12 and the cutaway side views in FIGS. 13-14. FIG. 11 depicts a perspective view of an embodiment of the connector assembly 200. The inner body assembly 210 forms a first end opening 201 configured to receive a first optical fiber extending from the first end 101. The inner body assembly 200 forms a second end opening 202 configured to receive a second optical fiber from the second end 102.

Referring to FIGS. 9-14, the inner body assembly 210 includes an inner body housing 220, a ferrule 230, a spring 240, a first crimp body 250, and a second crimp body 260, such as further described below.

The inner body assembly 210 forms a first end opening 201 configured to receive a first optical fiber, such as the first output cable 118, from the first end 101. In a particular embodiment, the inner body assembly 210 forms the first end opening 201 to receive the first output cable 118 into the first crimp body 250 and the second crimp body 260.

The inner body assembly 210 forms a second end opening 202 configured to receive a second optical fiber, such as the second output cable 122, from the second end 102. In a particular embodiment, the inner body assembly 210 forms the second end opening 202 to receive the second output cable 122 at the ferrule 230.

The second crimp body 260 surrounds at least a portion of the first crimp body 250 proximate to the first end 101 (e.g., distal to the second end 102). The inner body housing 220 surrounds at least a portion of the ferrule 230 and the spring 240. The inner body housing 220 is coupled proximate to the second end 102 (e.g., distal to the first end 101) at the first crimp body 250. The ferrule 230 extends along the longitudinal direction L within at least a portion of the inner body housing 220 and the first crimp body 250.

The spring 240 is positioned within the inner body housing 220. The spring 240 extends along longitudinal direction L. The spring 240 is positioned along the longitudinal direction L between at least a portion of the ferrule 230 and the first crimp body 250. The spring 240 is positioned to exert a force to the ferrule 230 and the first crimp body 250 along the longitudinal direction L.

FIGS. 15A-15B provide perspective views of an exemplary embodiment of the second crimp housing 260. FIGS. 16A-16B provide perspective views of an exemplary embodiment of halves of the first crimp housing 250. In particular embodiments, the first crimp body 250 includes at least two portions split along the longitudinal direction L. The first crimp body portions 250A, 250B are configured to crimp or press against a fiber optic cable, such as the first output cable 118. In particular, the portions 250A, 250B of the first crimp body 250 form a channel 252 extending along the longitudinal direction L into which the fiber optic cable may be positioned. The portions 250A, 250B include retainer features, such as pins, teeth, or other member 254 configured to mate into a corresponding orifice, slot, or other opening 256 at an adjacent portion 250A, 250B. Portions 250A, 250B may accordingly snap together and crimp, press, or clamp around an outer jacket surrounding an optical fiber.

Referring to FIGS. 15A-15B and FIGS. 16A-16B, and in conjunction with FIGS. 6-8, the first crimp body 250 surrounding the fiber optic cable is positioned into the second crimp body 260. In various embodiments, the second crimp body 260 is a unitary body configured to surround the first crimp body 250 and the fiber optic cable. In particular embodiments, the second crimp body 260 forms a slot 262 extending along the longitudinal direction L. The slot 262 is configured to receive a key 258 at the first crimp body 250 correspondingly extending along the longitudinal direction L. In still particular embodiments, the first crimp body 250 forms a slot 259 extending along an arc extending along circumferential direction C relative to the longitudinal direction L. In particular, first crimp body 250 may form a flange 257 extending along the radial direction R and along an arc along the circumferential direction C relative to the longitudinal direction L. The slot 259 is formed between arcuate portions of flange 257. Certain embodiments of the second crimp body 260 include a key 264 extending along the longitudinal direction L. The slot 259 is configured to receive the key 264. Accordingly, second crimp body 260 may compressor or crimp the first crimp body 250 around the fiber optic cable and inhibit rotation of the second crimp body 260 relative to the first crimp body 250.

FIGS. 17A-17B provide perspective views of an embodiment of the inner body housing 220. Referring now to the inner body housing 220 depicted at FIGS. 17A-17B and the first crimp body 250 depicted in FIGS. 16A-16B, and in conjunction with FIGS. 13-14, in various embodiments, the inner body housing 220 includes a plurality of ribs 222 extending longitudinal direction L. Ribs 222 form an opening 223 extending through the rib 222. In particular, opening 223 extends through the rib 222 along the radial direction R to allow clip 253 at first crimp housing 250 to insert along the radial direction R. First crimp body 250 forms a groove 255 between the clip 253 and the flange 257. Ribs 222 include a longitudinal end 224 configured to position into groove 255. In a particular embodiment, end 224 is formed at the inner body housing 220 along the longitudinal direction L proximate to first end 101 and distal to second end 102. Clip 253 at the first crimp housing 250 is secured between end 224 and a remaining rib portion at the inner body housing 220 toward second end 102 and accordingly secures the first crimp body 250 and the inner body housing 220 together along the longitudinal direction L. Furthermore, as described below, clip 253 may position along the longitudinal direction L the first crimp housing 250 and second output cable 122 relative to the inner body housing 220 and first output cable 118.

The inner housing body 220 forms a slot 221 extending along the longitudinal direction L. The first crimp housing 250 includes one or more ribs 251 extending along the longitudinal direction L and corresponding to the slot 221. Accordingly, ribs 251 are insertable into slot 221 along the longitudinal direction L. The first crimp body 250 and the inner body housing 220 are secured together relative to one another along the circumferential direction C when the rib 251 is inserted into slot 221.

FIG. 18 provides a perspective view of an exemplary embodiment of the ferrule 230. Ferrule 230 includes a shaft forming a first shaft end portion 231 proximate to the first end 101 and a second shaft end portion 232 proximate to the second end 102. A ferrule wall 236 extends along the radial direction R from the first shaft end portion 231. The ferrule wall 236 may form a seat at which the ferrule 230 positions within the inner body housing 220.

Referring now to FIGS. 13-14, FIGS. 17A-17B, and FIG. 18, the inner body housing 220 forms a ferrule opening 228 through which the ferrule 230 is extended. In particular, second shaft end portion 232 extends toward the second end 102 through the ferrule opening 228. A longitudinally extended slot 238 (FIG. 18) is formed at the ferrule wall 236 and configured to correspond to a ferrule retainer wall 226 at the inner body housing 220. The ferrule retainer wall 226 extends along the radial direction R from an inner diameter within the inner body housing 220. In certain embodiments, at least a portion of the ferrule retainer wall 226 extends along the longitudinal direction L to correspond with the slot 238 at the ferrule 230. Accordingly, the ferrule retainer wall 226 may position the ferrule 230 within the inner body housing 220 along the longitudinal direction L. The ferrule retainer wall 226 may further provide a feature to retain the ferrule 230 to the inner body housing 220. Accordingly, the second shaft end portion 232 of the ferrule 230 may float or otherwise form a non-contacting arrangement relative to the ferrule opening 228 and a surrounding inner diameter of the inner body housing 220.

Referring generally to FIGS. 9-18, the ferrule wall 236 may provide a surface at which spring 240 reacts along the longitudinal direction L against the ferrule 230. The spring 240 allows the ferrule 230 to deflect during assembly of the jack at the connector adapter 290 at the fiber optic cable to plug or male connector 208. Allowing for spring deflection may particularly allow for more precise connection of the jack at connector adapter 290 and plug 208. As such, connections provided by the connector assembly 200 may decrease optical insertion losses and improve fiber optic connection performance.

Additionally, the force exerted by the spring 240 onto ferrule 230 may provide sealing between the ferrule wall 236 and the ferrule retainer wall 226. The force of the spring 240 onto the ferrule 230 and the inner body housing 220 may desirably inhibit fluid communication through an opening through which second ferrule portion end 232 extends along the longitudinal direction L across the ferrule retainer wall 226.

Referring back to FIG. 9 and FIGS. 10A-10B, embodiments of the connector assembly 200 may include a first connector body 270 coupled and a second connector body 280. FIG. 19 depicts a perspective view of an exemplary first connector body 270. FIGS. 20-22 provide views of an exemplary second connector body 280. Referring to FIG. 9 and FIGS. 10A-10B, and further depicted at FIG. 19 and FIG. 22, the first connector body 270 and the second connector body 280 each form corresponding threaded interfaces 272, 282 configured to receive one another. In particular, the threaded interface 272 at the first connector body 270 forms an outer diameter thread configured to receive an inner diameter thread formed by the threaded interface 282 at the second connector body 280. Accordingly, the second connector body 280 is releasably attachable to the first connector body 270 at the threaded interface 272, 282. In particular embodiments, the second connector body 280 is releasably attachable to the first connector body 270 at the threaded interface 272, 282 between the first end 101 and the second end 102 of the inner body assembly 210, or particularly between the first end opening 201 and the second end opening 202.

Various embodiments of the first connector body 270 may form a substantially cylindrical body extending along the longitudinal direction L. In certain embodiments, the first connector body 270 forms a BNC nut or other appropriate body and fastener. In particular embodiments, the first connector body 270 extends along the longitudinal direction L from the first end 101 to circumferentially surround the second crimp body 260 and at least a portion of the first crimp body 250. In still particular embodiments, the second connector body 280 extends along the longitudinal direction L from the second end 102 to circumferentially surround the inner body housing 220 and at least a portion of the first crimp body 250. In certain embodiments, the second connector body 280 circumferentially surrounds a portion 274 of the first connector body 270. In various embodiments, the threaded interface 272, 282 is positioned along the longitudinal direction L around the first crimp body 250. In certain embodiments, a seal 275 is disposed between the first connector body 270 and the second connector body 280 at the overlapping portion 274.

Referring to FIG. 12, in a particular embodiment of the connector assembly 200 and method for construction, the inner body assembly 210 is assembled to the first output cable 118. In particular, an optical fiber 119 of the first output cable 118 extends into the inner body assembly 210 and into ferrule 230, such as depicted in FIG. 10A, FIG. 10B, and FIG. 14. In a particular embodiment, the first crimp body 250 is affixed to a fiber optic cable, such as the first output cable 118 (FIG. 2, FIGS. 10A-10B). In a still particular embodiment, the first crimp body 250 is pressed or pushed into the cable, such as pressed or pushed within the outer jacket 123. Strength fibers 121 extend toward the second end 102 from within the outer jacket 123. The second crimp body 260 joins the first crimp body 250 together and to the first output cable 118, such as depicted at FIG. 12. The strength fibers 121 extend between the first crimp body 250 and the second crimp body 260 and egress from an outlet opening or gap 261 extended between the first crimp body 250 and the second crimp body 260, such as depicted in FIG. 13. In a particular embodiment, a gap 263 is formed between flange 257 and the second end 102 of the second crimp body 260. In a still particular embodiment, gap 263 extends at least partially along a circumferential arc between flange 257 and the second end 102 of the second crimp body 260. Gap 261 may connect to gap 263 and allow strength fiber 121 to egress from gap 261 (FIG. 13) through gap 263 (FIG. 12).

Referring to FIG. 10B and FIG. 13, the second crimp body 260 may form a first cavity 271 between an outer portion of the first crimp body 250 at the first end 101 and an inner portion of the second crimp body 260. The strength fiber 121 extending from the outer jacket 123 is positioned at least partially in the first cavity 271. The strength fiber 121 may extend into the first cavity 271 toward the second end 102 from the output cable 118. The strength fiber 121 may further extend around the second end 102 of the second crimp body 260 and back toward the first end 101 and outside of the second crimp body 260.

The first connector body 270 is attached to the inner body assembly 210 surrounding the second crimp body 260. The strength fiber 121 may furthermore extend past the first connector body 270 toward the first end 101. A second cavity 273 may be formed between the outer jacket 123 of the output cable 118 and an inner surface of the first connector body 270. The strength fiber 121 may extend toward or into the second cavity 273. In various embodiments, it should be appreciated that the strength fiber 121 may be cut and kept between the first connector body 270 and the second crimp body 260, or cut and kept at the first cavity 271.

The spring 240 and ferrule 230 are each inserted into the first crimp body 250 and the inner body housing 220 couples to the first crimp body 250 (e.g., clip 253 at first crimp body 250 coupling to inner body housing 220 at opening 223). A sheath 233 may furthermore surround the ferrule 230, or particularly second shaft end portion 232 of ferrule 230 (FIG. 10A, FIG. 10B, FIG. 14). The sheath 233 may form a guide or sleeve desirably positioning the ferrule 230 within-tube 288. Slots 221, 259. 262 provide alignment and limit twisting and rotation of first crimp body 250 and second crimp body 260 relative to the inner body housing 220 and ferrule 230.

Referring to FIG. 9 and FIGS. 10A-10B, in particular embodiments, the inner body assembly 210 is installed into the first connector body 270. A stop wall 276 at the first connector body 270 limits movement or otherwise positions the inner body assembly 210 along the longitudinal direction L. In particular, the second crimp body 260 forms a step or face 266 (FIGS. 13-14) configured to abut the stop wall 276 along the longitudinal direction L. Seal 275, such as an O-ring, rope seal, or other sealant material or solution, may be disposed at an appropriate surface at the first connector body 270, such as corresponding to portion 274. Additionally, or alternatively, seal 275 may position at a seal groove 285 (FIG. 22) formed adjacent to the threaded interface 282 at the second connector body 280. The second connector body 280 threads or otherwise attaches to the first connector body 270, such as at the threaded interface 272, 282. In particular embodiments, second connector body 280 may be attached to a fiber optic connector 208 configured to provide a terminal end to the second output cable 122 (FIG. 2). A stop wall 286 at the second connector body 280 limits movement or otherwise positions the inner body assembly along the longitudinal direction L. Threading together the first connector body 270 and the second connector body 280 encases the inner body assembly 210, such as to provide an environmental sealing of the optical fiber for outside plant (OSP) conditions.

In certain embodiments, the stop wall 286 is configured to abut against the inner body housing 220 to limit movement of the inner body assembly 210 toward the second end 102. Spring 240 is activated or loaded as the inner body housing 220 is attached to the first crimp body 250. When the inner body housing 220 is mated to the first crimp body 250, the spring 240 is activated to generate a preload. In certain embodiments, the inner body assembly 210 is configured to abut a radially extended end wall 229 of the inner body housing 220 to the stop wall 286.

In various embodiments, further retention and sealing may be provided by heat shrink wrap, hosing, tubing, or other seals 212, 214 surrounding the first connector body 270 and extending to the first output cable 118 and surrounding the second output cable 122 at the connector 208.

Referring briefly to FIGS. 20-22, embodiments of the second connector body 280 may include a nose or tube 288 forming a channel into which the second ferrule end portion 232 of the ferrule 230 is extendable (FIG. 6). The tube 288 is further configured to receive a plug or male connector 208 (FIG. 2) from the second output cable 122.

Referring now to FIGS. 23-25, exemplary embodiments of a fiber optic jack adapter or connector adapter 290 are provided. The connector adapter 290 includes a terminal 293 configured to receive a fiber optic connector, such as, but not limited to, an SC connector, an ST connector, an LC connector, or any other appropriate type of telecommunications or fiber optic connector, or any other appropriate type of single fiber connector. Connector adapter 290 may include a twist lock nose 291 for connecting terminated ends.

A restraining device 296 may be attached to the connector adapter 290 and configured to connect to the second connector body 280. Restraining device 296 includes one or more rings 292 connected to a strap 294. Restraining device 296 may form a lanyard configured to retain the connector assembly 200 or cable assembly 100 to the second output cable 122 (FIG. 2).

Referring now to FIGS. 26-27, views of an embodiment of a fiber optic connector assembly 300 (hereinafter, “connector assembly 300”) are provided. Embodiments of the connector assembly 300 may include components configured substantially as described in regard to connector assembly 200. The connector assembly 300 includes a fiber optic connector 310 including a ferrule assembly 330 extending along the longitudinal direction L at least partially within a middle body 390. A connector jack body 380 supports the ferrule assembly 330 into the middle body 390 and provides a coupling location to receive the second output cable 122 (FIG. 2). An outer body 400 surrounding the middle body 390 releasably attaches to the middle body 390 and the connector jack body 380, such as described herein.

The ferrule assembly 330 includes a ferrule body 320 configured to support an input fiber 331 (e.g., from first output cable 118) and a ferrule end portion 332 configured to receive a second optical fiber (e.g., from second output cable 122). In an embodiment such as depicted in FIG. 27, ferrule assembly 330 may be configured as an SC connector or equivalent. In other embodiments, ferrule assembly 330 may be configured as an ST connector, an LC connector, or any other appropriate type of telecommunications or fiber optic connector, or any other appropriate type of single fiber connector.

A first crimp body 350 is configured to receive and affix to the first output cable 118. Certain embodiments of the first crimp body 350 may be configured substantially in accordance with embodiments of first crimp body 350, such as depicted and described in regard to FIGS. 16A-16B. A second crimp body 360 is configured to affix around the first crimp body 350. Certain embodiments of the second crimp body 360 may be substantially configured in accordance with embodiments of the second crimp body 260, such as depicted and described in regard to FIGS. 15A-15B.

Referring now to FIGS. 28-24, view of an embodiment of the middle body 390 are provided. Middle body 390 includes a substantially cylindrical body 392 extending along the longitudinal direction L. A stop wall 394 extends outward along the radial direction R from the cylindrical body 392. The stop wall 394 is configured to abut against a corresponding stop wall 494 extending inward along the radial direction R from a cylindrical body 492 at outer body 400, such as depicted in FIG. 26 and FIGS. 31-26. In particular embodiments, bodies 392, 492 form threaded interfaces 402 at stop walls 394, 494 allowing for middle body 390 and outer body 400 to releasably affix to one another.

Referring particularly to the cutaway side view depicted in FIG. 30, middle body 390 may further include a nose or tube 396 forming a channel into which the ferrule end portion 332 of the ferrule assembly 330 is extendable (FIG. 26). The tube 396 is further configured to receive a plug or male connector 208 (FIG. 2) from the second output cable 122. A seal groove 385 may be formed at the tube 396 and configured to receive a sealing material or seal 375. Seal 375 may be configured substantially as described in regard to seal 275. Seal 375 is configured to inhibit fluid communication between the middle body 390 and an embodiment of the first connector body 270 surrounding at least a portion of the second crimp body 360, the first crimp body 350, and the middle body 390. In particular, first connector body 270 may releasably attach to the tube 396 at the middle body 390. In some embodiments, tube 396 includes a threaded interface configured to couple to the threaded interface 272 at the first connector body 270.

Referring still to FIG. 30, middle body 390 forms a seal groove 397 at which a seal 395 may be positioned. Seal groove 397 is configured to position seal 395 between the middle body 390 and the connector jack body 380. The connector jack body 380 is configured to attach to the second output cable 122, such as at one or both of interfaces 388, 389. In a particular embodiment, connector 208 (FIG. 2) is configured attach to a tube or other appropriate interface 388 at the connector jack body 380.

Referring to FIGS. 31-26, an embodiment of the outer body 400 is provided. FIG. 31 provides a perspective view of an embodiment of the outer body 400. FIG. 32 provides a cutaway side view of the outer body 400 of FIG. 31. Referring to FIGS. 30-25, and further depicted in FIG. 26, outer body 400 and connector jack body 380 are releasably coupled together at a threaded interface 382. In a particular embodiment, outer body 400 includes a threaded interface 404 internal to body 492.

Embodiments of the connector assembly 200, 300 provided herein expand mounting options between a module or closure 14 and an OSP location, such as a drop cable 16 or connection terminal 28. Such expanded mounting options allow for reduced cable routing footprint and allows for cable routing to be stored in smaller spaces in contrast to known multi-port connection terminals. Embodiments of the connector assembly 200, 300 may additionally, or alternatively, be utilized as a cable extension device.

Further aspects and embodiments of the present subject matter are provided in the following clauses:

1. A fiber optic connector assembly, the fiber optic connector assembly defining a first end and a second end each separated along a longitudinal direction corresponding to a longitudinal extension of a cable, the fiber optic connector assembly including an inner body assembly extending along the longitudinal direction, wherein the inner body assembly includes an inner body housing, a ferrule, a spring, a first crimp body, and a second crimp body, wherein the second crimp body surrounds at least a portion of the first crimp body proximate to the first end, wherein the inner body housing surrounds at least a portion of the ferrule and the spring, and wherein the inner body housing is coupled proximate to the second end at the first crimp body, wherein the spring is positioned within the inner body housing, and wherein the spring extends along the longitudinal direction, and wherein the spring is positioned along the longitudinal direction between at least a portion of the ferrule and the first crimp body, the spring positioned to exert a force to the ferrule and the first crimp body along the longitudinal direction, wherein the ferrule extends along the longitudinal direction within at least a portion of the inner body housing and the first crimp body, wherein the inner body assembly forms a first end opening configured to receive a first optical fiber from the first end into the first crimp body and the second crimp body, and wherein the inner body assembly forms a second end opening configured to receive a second optical fiber from the second end at the ferrule.

2. The fiber optic connector assembly of any one or more clauses herein, the fiber optic connector assembly including a first connector body coupled to the second crimp body and surrounding at least a portion of the first crimp body; and a second connector body coupled to the inner body housing, wherein the second connector body is releasably attached to the first connector body.

3. The fiber optic connector assembly of claim 2, wherein the second connector body is releasably attached to the first connector body via a threaded interface between the first end and the second end at the inner body assembly.

4. The fiber optic connector assembly of any one or more clauses herein, wherein the second connector body surrounds at least a portion of the first crimp body, and wherein the first connector body and the second connector body together surround the inner body assembly.

5. The fiber optic connector assembly of any one or more clauses herein, wherein the first connector body forms a first stop wall configured to abut a face at the second crimp body.

6. The fiber optic connector of any one or more clauses herein, wherein the second connector body forms a second stop wall configured to abut the inner body housing to limit movement of the inner body assembly along the longitudinal direction toward the second end.

7. The fiber optic connector assembly of any one or more clauses herein, wherein the first crimp body includes at least two portions split along the longitudinal direction.

8. The fiber optic connector assembly of any one or more clauses herein, wherein the second crimp body forms a slot extending along the longitudinal direction and configured to receive a key at the first crimp body.

9. The fiber optic connector assembly of any one or more clauses herein, wherein the inner body housing forms a ferrule retainer wall extending along a radial direction from an inner diameter within the inner body housing.

10. The fiber optic connector assembly of any one or more clauses herein, wherein the ferrule retainer wall provides a surface at which the spring reacts along the longitudinal direction against the ferrule.

11. A fiber optic drop cable assembly, the fiber optic drop cable assembly defining a first end and a second end each separated along a longitudinal direction, the fiber optic drop cable assembly including a transition apparatus configured to receive a connectorized multi-fiber input cable and forming an output end forming one or more openings from which respective one or more first output cables extend; a fiber optic connector assembly including an inner body assembly extending along the longitudinal direction, wherein the inner body assembly includes an inner body housing, a ferrule, a spring, a first crimp body, and a second crimp body, a first connector body coupled to the second crimp body and surrounding at least a portion of the first crimp body, wherein each first output cable is configured to be received at each respective fiber optic connector assembly at the first connector body; a second connector body coupled to the inner body housing, wherein the second connector body is releasably attached to the first connector body, the first connector body and the second connector body together surrounding the fiber optic connector assembly; and a second output cable extending from the second connector body.

12. The fiber optic drop cable assembly of any one or more clauses herein, wherein the first output cable and the second output cable is a hardened single fiber drop cable.

13. The fiber optic drop cable assembly of any one or more clauses herein, wherein the first crimp body includes at least two portions split along the longitudinal direction, and wherein the second crimp body surrounds at least a portion of the first crimp body proximate to the first end.

14. The fiber optic drop cable assembly of any one or more clauses herein, wherein the first crimp body is affixed to the first output cable, and wherein the second crimp body joins the first crimp body to the first output cable via the first connector body.

15. The fiber optic drop cable assembly of any one or more clauses herein, wherein the spring and the ferrule are each inserted into the first crimp body and the inner body housing.

16. The fiber optic drop cable assembly of any one or more clauses herein, wherein a ferrule retainer wall at the inner body housing provides a surface at which the spring reacts along the longitudinal direction against the ferrule.

17. The fiber optic drop cable assembly of any one or more clauses herein, wherein a clip at the first crimp body couples the first crimp body to the inner body housing.

18. The fiber optic drop cable assembly of any one or more clauses herein, wherein the first connector body forms a first stop wall configured to abut a face at the second crimp body, and wherein the second connector body forms a second stop wall configured to abut the inner body housing to limit movement of the inner body assembly along the longitudinal direction toward the second end.

19. The fiber optic drop cable assembly of any one or more clauses herein, wherein the first connector body is configured to receive a first male connector from the first output cable, and wherein the second connector body is configured to receive a second male connector from the second output cable.

20. The fiber optic drop cable assembly of any one or more clauses herein, wherein the spring is positioned within the inner body housing, and wherein the spring extends along the longitudinal direction, and wherein the spring is positioned along the longitudinal direction between at least a portion of the ferrule and the first crimp body, the spring positioned to exert a force to the ferrule and the first crimp body along the longitudinal direction.

21. The fiber optic drop cable assembly of any one or more clauses herein, wherein one or more of the first crimp body, the second crimp body, or the inner body housing forms a slot extending along the longitudinal direction and configured to limit rotation of the first crimp body and the second crimp body relative to the inner body housing the ferrule.

22. A fiber optic connector assembly, the fiber optic connector assembly defining a first end and a second end each separated along a longitudinal direction corresponding to a longitudinal extension of a cable, the fiber optic connector assembly including an inner body assembly extending along the longitudinal direction, wherein the inner body assembly includes an inner body housing, a fiber optic connector, a spring, a first crimp body, and a second crimp body, wherein the second crimp body surrounds at least a portion of the first crimp body proximate to the first end, wherein the inner body housing is coupled proximate to the second end at the first crimp body, wherein the fiber optic connector extends along the longitudinal direction within at least a portion of the inner body housing and the first crimp body, wherein the inner body assembly forms a first end opening configured to receive a first optical fiber from the first end into the first crimp body and the second crimp body, and wherein the inner body assembly forms a second end opening configured to receive a second optical fiber from the second end at the fiber optic connector.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A fiber optic connector assembly, the fiber optic connector assembly defining a first end and a second end each separated along a longitudinal direction corresponding to a longitudinal extension of a cable, the fiber optic connector assembly comprising:
an inner body assembly extending along the longitudinal direction, wherein the inner body assembly comprises an inner body housing, a ferrule, a spring, a first crimp body, and a second crimp body,
wherein the second crimp body surrounds at least a portion of the first crimp body proximate to the first end,
wherein the inner body housing surrounds at least a portion of the ferrule and the spring, and wherein the inner body housing is coupled proximate to the second end at the first crimp body,
wherein the spring is positioned within the inner body housing, and wherein the spring extends along the longitudinal direction, and wherein the spring is positioned along the longitudinal direction between at least a portion of the ferrule and the first crimp body, the spring positioned to exert a force to the ferrule and the first crimp body along the longitudinal direction,
wherein the ferrule extends along the longitudinal direction within at least a portion of the inner body housing and the first crimp body,
wherein the inner body assembly forms a first end opening configured to receive a first optical fiber from the first end into the first crimp body and the second crimp body,
wherein the inner body assembly forms a second end opening configured to receive a second optical fiber from the second end at the ferrule.

2. The fiber optic connector assembly of claim 1, the fiber optic connector assembly comprising:
a first connector body coupled to the second crimp body and surrounding at least a portion of the first crimp body; and
a second connector body coupled to the inner body housing, wherein the second connector body is releasably attached to the first connector body.

3. The fiber optic connector assembly of claim 2, wherein the second connector body is releasably attached to the first connector body via a threaded interface between the first end and the second end at the inner body assembly.

4. The fiber optic connector assembly of claim 2, wherein the second connector body surrounds at least a portion of the first crimp body, and wherein the first connector body and the second connector body together surround the inner body assembly.

5. The fiber optic connector assembly of claim 2, wherein the first connector body forms a first stop wall configured to abut a face at the second crimp body.

6. The fiber optic connector of claim 5, wherein the second connector body forms a second stop wall configured to abut the inner body housing to limit movement of the inner body assembly along the longitudinal direction toward the second end.

7. The fiber optic connector assembly of claim 1, wherein the first crimp body comprises at least two portions split along the longitudinal direction.

8. The fiber optic connector assembly of claim 1, wherein the second crimp body forms a slot extending along the longitudinal direction and configured to receive a key at the first crimp body.

9. The fiber optic connector assembly of claim 1, wherein the inner body housing forms a ferrule retainer wall extending along a radial direction from an inner diameter within the inner body housing.

10. The fiber optic connector assembly of claim 9, wherein the ferrule retainer wall provides a surface at which the spring reacts along the longitudinal direction against the ferrule.

11. A fiber optic drop cable assembly, the fiber optic drop cable assembly defining a first end and a second end each separated along a longitudinal direction, the fiber optic drop cable assembly comprising:
a transition apparatus configured to receive a connectorized multi-fiber input cable and forming an output end forming one or more openings from which respective one or more first output cables extend;
a fiber optic connector assembly comprising an inner body assembly extending along the longitudinal direction, wherein the inner body assembly comprises an inner body housing, a ferrule, a spring, a first crimp body, and a second crimp body,
a first connector body coupled to the second crimp body and surrounding at least a portion of the first crimp body, wherein each first output cable is configured to be received at each respective fiber optic connector assembly at the first connector body;
a second connector body coupled to the inner body housing, wherein the second connector body is releasably attached to the first connector body, the first connector body and the second connector body together surrounding the fiber optic connector assembly; and
a second output cable extending from the second connector body.

12. The fiber optic drop cable assembly of claim 11, wherein the first output cable and the second output cable is a hardened single fiber drop cable.

13. The fiber optic drop cable assembly of claim 11, wherein the first crimp body comprises at least two portions split along the longitudinal direction, and wherein the second crimp body surrounds at least a portion of the first crimp body proximate to the first end.

14. The fiber optic drop cable assembly of claim 11, wherein the first crimp body is affixed to the first output cable, and wherein the second crimp body joins the first crimp body to the first output cable via the first connector body.

15. The fiber optic drop cable assembly of claim 14, wherein the spring and the ferrule are each inserted into the first crimp body and the inner body housing.

16. The fiber optic drop cable assembly of claim 15, wherein a ferrule retainer wall at the inner body housing provides a surface at which the spring reacts along the longitudinal direction against the ferrule.

17. The fiber optic drop cable assembly of claim 11, wherein the first connector body forms a first stop wall configured to abut a face at the second crimp body, and wherein the second connector body forms a second stop wall configured to abut the inner body housing to limit movement of the inner body assembly along the longitudinal direction toward the second end.

18. The fiber optic drop cable assembly of claim 11, wherein the first connector body is configured to receive a first male connector from the first output cable, and wherein the second connector body is configured to receive a second male connector from the second output cable.

19. The fiber optic drop cable assembly of claim 11, wherein the spring is positioned within the inner body housing, and wherein the spring extends along the longitudinal direction, and wherein the spring is positioned along the longitudinal direction between at least a portion of the ferrule and the first crimp body, the spring positioned to exert a force to the ferrule and the first crimp body along the longitudinal direction.

20. The fiber optic drop cable assembly of claim 11, wherein one or more of the first crimp body, the second crimp body, or the inner body housing forms a slot extending along the longitudinal direction and configured to limit rotation of the first crimp body and the second crimp body relative to the inner body housing the ferrule.
